(19) United States
(12) Patent Application Publication
(10) Pub. No.: US 2022/0003689 A1
(43) Pub. Date: Jan. 6, 2022

(54) X-RAY GENERATING APPARATUS FOR PHASE IMAGING

(71) Applicant: Tohoku University, Sendai-shi, Miyagi (JP)

(72) Inventors: Asao Nakano, Sendai-shi (JP); Atsushi Momose, Sendai-shi (JP)

(21) Appl. No.: 16/650,284

(22) PCT Filed: Feb. 17, 2020
(86) PCT No.: PCT/JP2020/006082

§ 371 Date: Mar. 24, 2020

(51) Int. Cl. G01N 23/041; H01J 35/08; G21K 1/06

(52) U.S. Cl. CPC G01N 23/041; H01J 35/08; H01J 2235/1262; H01J 2235/084; G21K 1/06

(57) ABSTRACT

An electron source irradiates a target by inclining an electron beam at a predetermined irradiation angle θ with respect to a perpendicular to a target substrate. In this way, it is possible to extract grating-shaped X-rays in a direction perpendicular to the target substrate. The target substrate includes a substance containing a light element. On a surface of the target substrate, a plurality of grooves periodically disposed in a one-dimensional or two-dimensional direction to have a grating shape is formed. X-ray generating portions are arranged in a grating shape by being embedded in the plurality of grooves formed in the target substrate. The X-ray generating portions are made of a metal including W, Ta, Pt or Au or an alloy thereof. A depth M of the X-ray generating portions arranged in the grating shape is set within a predetermined range. The generation efficiency of X-rays for phase imaging is improved.

### BACKGROUND

### Technical Field

The present disclosure relates to an apparatus for generating an X-ray for phase imaging.

### Description of the Related Art

An X-ray has a high transmission property in a substance, and imaging using the X-ray is widely used to observe an internal structure of a sample, which corresponds to a scheme of irradiating a sample with an X-ray and projecting the X-ray passing through the sample onto a detector to see through a structure inside the sample, so that a projection image reflecting the X-ray absorption of a sample object is obtained (for example, see Non-Patent Document 1 below).

Further, a scheme of forming a three-dimensional (3D) image of a sample from plural X-ray projection images captured at different directions is known, for example, from Non-Patent Document 2 below. In addition, there has been known a phase imaging technology for generating an X-ray image using a phase change of an X-ray passing through a sample. This technology uses a scheme of detecting the phase of the X-ray using an X-ray grating (for example, Non-Patent Document 3 below). This Non-Patent Document 3 describes a method for manufacturing the X-ray grating. Using X-ray phase imaging allows a clear X-ray image to be obtained using information about a phase change caused by a sample, even for a substance having a low X-ray absorption (a sample made of a substance having a relatively low atomic number, for example, a biological tissue).

A Talbot-Lau interferometer has been known as an example of an X-ray phase imaging apparatus (see Non-Patent Document 4 below). In general, the Talbot-Lau interferometer disposes three gratings in an X-ray path to acquire X-ray phase imaging data. The three gratings are referred to as a grating G0, a grating G1, and a grating G2 in order from a radiation source side. The grating G0 is an absorption grating, and is installed on a downstream side of an X-ray source that emits an X-ray with a certain spread. An X-ray shielding portion and an X-ray transmitting portion are periodically arranged in the grating G0. Due to this property, the grating G0 has a role of geometrically arranging a large number of micro X-ray sources in a pseudo manner at an interval of a grating pitch. In this way, even when a radiation source that generates an X-ray having a low spatial coherence, that is, an X-ray involving multi-wavelength X-rays is used as the radiation source, an X-ray having a high spatial coherence can be irradiated from a micro X-ray source enough to realize the phase imaging, and thus it is possible to realize the phase imaging. That is, the grating G0 may form a part of the radiation source. The grating G1 is a phase grating in which a desired phase change occurs at a wavelength of an X-ray used for imaging by adjusting a material and thickness of the X-ray shielding portion of the grating. The grating G2 is generally an absorption grating, and an installation position or a grating period thereof is adjusted so that a moire image is generated with respect to an image of the grating G1. In a fringe scanning method, while moving one of the grating G1 and the grating G2 relative to the other by a relatively small amount in a period direction of the grating, a changing projection image is acquired by an X-ray image detector, and then data processing of the projection image is performed. In this way, it is possible to acquire a necessary X-ray phase image (so-called phase imaging).

Here, in the grating G0 and the grating G2, a part for completely shielding the X-ray and a part for transmitting without attenuation need to be periodically formed with a predetermined grating pitch in terms of functions. Here, in the case of desiring to increase the spatial resolution of the phase imaging, it is necessary to reduce the grating pitch. However, to effectively shield the X-ray, it is generally necessary to form a heavy metal material sufficiently thick. For this reason, an X-ray shielding portion having a high aspect ratio needs to be formed. Depending on the energy of the X-ray, for example, it is necessary to form a grating pattern having a high aspect ratio of 10 or more, which causes considerable difficulty in manufacturing the grating.

As one solution to the difficulty, a phase imaging measurement scheme referred to as a Lau interferometer has been proposed as described in Non-Patent Document 5 below. According to this scheme, there is an advantage that it is possible to omit the grating G2 that requires creation of a grating having a large area and a high aspect ratio. Furthermore, the grating G0 can be omitted using an X-ray radiation source that generates a grating-patterned X-ray.

### CITATION LIST

### Non-Patent Documents

Non-Patent Document 1: Y. Yoneda: New Emission X-ray Microscope, Review of Scientific Instruments, Vol. 33, (1962), 529-532
Non-Patent Document 2: Momose, A., Fujii, A., Kadowaki, H., and Jinnai, H.: Three-Dimensional Observation of Polymer Blend by X-ray Phase Tomography,

Macromolecules 38 (2005), 7197-7200
Non-Patent Document 3: C. Grunzweig, F. Pfeiffer, O. Bunk, T. Donath, G. Kuhne, G. Frei, M. Dierolf, and C. David: Design, fabrication, and characterization of diffraction gratings for neutron phase contrast imaging, REVIEW OF SCIENTIFIC INSTRUMENTS 79 (2008), 0537031-6
Non-Patent Document 4: Momose A, Kawamoto S, Koyama I, Hamaishi Y, Takai K, and Suzuki Y: Demonstration of X-Ray Talbot interferometry, JAPANESE JOURNAL OF APPLIED PHYSICS PART 2-LETTERS & EXPRESS LETTERS 427B (2003) L866-868
Non-Patent Document 5: Takayoshi Shimura, Naoki Morimoto, Sho Fujino, Takaharu Nagatomi, Keni-chi Oshima, Jimpei Harada, Kazuhiko Omote, Naohisa Osaka, Takuji Hosoi, 1 and Heiji Watanabe: Hard x-ray phase contrast imaging using a tabletop Talbot-Lau interferometer with multiline embedded x-ray targets, OPTICS LETTERS, Vol. 38, No. 2 (2013), 157-159
Non-Patent Document 6: Atsushi Momose, Hiroaki Kuwabara, and Wataru Yashiro: X-ray Phase Imaging Using Lau Effect, Applied Physics Express 4 (2011), 0666031-3
Non-Patent Document 7: K Kanaya and S Okayama: Penetration and energy-loss theory of electrons in solid targets, Journal of Physics D: Applied Physics 5 (1972), 43-58
Non-Patent Document 8: John A. Victoreen: MEASUREMENT OF THE PHOTON SPECTRUM FROM AN X-RAY TUBE ABOVE 10 keV USING THE INDUCED XRF TECHNIQUE, Nuclear Instruments and Methods in Physics Research A242 (1985), 143-148
Non-Patent Document 9: Wataru Yashiro, Yoshihiro Takeda, and Atsushi Momose: Efficiency of capturing a phase image using conebeam x-ray Talbot interferometry, Journal of Optical Society of America A, Vol. 25, No. 8 (2008), 2025-2039

### PATENT DOCUMENTS

Patent Document 1: Japanese Patent No. 4,189,770
Patent Document 2: Japanese Patent No. 5,153,388
Patent Document 3: Japanese Patent No. 5,158,699
Patent Document 4: Japanese Patent No. 5,548,189
Patent Document 5: JP-A-2015-047306
Patent Document 6: JP-A-2015-077289
Patent Document 7: US 2015/0092924
Patent Document 8: US 2015/0117599
Patent Document 9: US 2015/0243397
Patent Document 10: US 2015/0260663
Patent Document 11: US 2016/0064175
Patent Document 12: US 2016/0066870

### BRIEF SUMMARY

### Technical Problem

In the example of Patent Document 1 described above, an anode is formed from a patterned or single-layer thin-film metal material, and the anode is interposed by a support film made of a light element through which an electron beam can easily pass to form a target. By diverting a semiconductor manufacturing technology to formation of the pattern of the thin-film metal material that generates an X-ray, the pattern of the thin-film metal material can be manufactured with submicrometer accuracy. In this technology, an antistatic film for removing an electric charge generated by passage of an electron beam through a target substrate is placed on a surface of the support film. However, conductivity of the thin-film metal material to be the anode of the target is not considered. Further, in this technology, since direct cooling of the target substrate is not considered, it is difficult to apply power of several tens of W or more to the target.

In the technology of Patent Document 2, the thin-film metal material serving as the anode is formed in a striped pattern to ensure electric conduction, and heat is applied to a water-cooled metal block via a diamond layer with high thermal conductivity disposed under the thin-film metal material, thereby intending to improve electron beam applied power and X-ray focal position accuracy. However, this technology does not particularly consider extraction of an X-ray in a stripe pattern shape, and proposes to extract an X-ray in parallel with a stripe at a low angle of about 3 to 12 degrees with respect to the target surface. The stripe pattern in the technology of Patent Document 2 is formed by a semiconductor manufacturing technology as in Patent Document 1. A lower limit of a stripe width is set to about 5 μm.

The technology of Patent Document 3 described above is related to the Talbot-Lau interferometer. This document describes a technology for generating an X-ray in a stripe pattern shape using a rotating target. In addition, Patent Document 4 describes an apparatus for generating an X-ray in a stripe pattern shape using a rotating target or a fixed target. In a rotating target type X-ray generating apparatus, by cooling a target portion irradiated with an electron beam while rotating the target portion at a high speed of 6,000 to 12,000 rpm in an actual example, high-power electron beam irradiation is allowed, and the X-ray generation intensity is increased. However, in this technology, rotation-induced vibration blur occurs in a rotation target rotation axis in a direction perpendicular or parallel to the rotation axis. Since there is a limit to the machining accuracy, even when the machining accuracy is improved, it is considered that a shake amplitude of 2 to 3 μm may occur. Therefore, the rotating target type X-ray generating apparatus is not suitable for high spatial resolution imaging. Patent Documents 3 and 4 propose a scheme of reducing an apparent axis blurring amount (rotational axis direction blurring mount) to 1/10 by setting an X-ray extraction angle to 6 degrees in the rotating target type X-ray generating apparatus. In addition, Patent Document 4 proposes a scheme of reducing an apparent plane size of an X-ray focal point while increasing the electron beam irradiation power by setting the X-ray extraction angle to about 6 degrees in the fixed target type. However, in such a technology, there is a problem that a visual field size of the phase imaging by the Talbot-Lau interferometer is limited.

Incidentally, conventionally, in the case of irradiating a target having a grating structure with an electron beam, the electron beam is irradiated from a direction perpendicular to a target surface. In this case, a portion (substrate portion), in which there is no metal pattern for X-ray generation, hardly does not contributes to X-ray generation.

As a result of various studies on improvement of X-ray generation efficiency, the inventors have found that X-ray generation efficiency can be greatly improved by setting a depth (M) of a metal pattern for X-ray generation (X-ray generating portion) in a predetermined range after tilting irradiation of an electron beam. The disclosure has been made based on this finding.

### Solution to Problem

(Item 1) An X-ray generating apparatus for X-ray phase imaging using an X-ray excited by an electron beam irradiated from an electron source onto a target,
in which the target includes a target substrate formed in a flat plate shape, and X-ray generating portions arranged in a grating shape on the target substrate,
the electron source is configured such that a grating-shaped X-ray is allowed to be extracted in a direction perpendicular to the target substrate by irradiating the target with the electron beam inclined at a predetermined irradiation angle (θ) with respect to a perpendicular to the target substrate,
the target substrate includes a substance containing an element having an atomic number of 14 or less,
plural grooves periodically disposed in a one-dimensional (1D) or two-dimensional (2D) arrangement to have a grating shape is formed on a surface of the target substrate,
the X-ray generating portions are arranged in a grating shape by being embedded in the plural grooves formed on the target substrate,
the X-ray generating portions contain a metal including W, Ta, Pt, or Au, or an alloy thereof, and
a depth (M) of the X-ray generating portions arranged in the grating shape is set to satisfy

D≤M≤D+r,
where r is a difference (r=R−X_{D}) between a maximum penetration depth (R) of X-ray excitation electrons irradiated as the electron beam in the X-ray generating portions and a penetration distance (X_{D}) of the X-ray excitation electrons in the X-ray generating portions, and
D is a penetration depth of the X-ray excitation electrons passing through the X-ray generating portions and the target substrate in a direction perpendicular to the target substrate.

(Item 2) The X-ray generating apparatus according to item 1, in which a ratio (a:b) of a grating width (a) of the X-ray generating portions to a grating width (b) of the target substrate is set to 1:2, and

a grating pitch (a+b) is set to be equal to or less than a penetration distance of the X-ray excitation electrons passing through both the target substrate and the X-ray generating portions.

(Item 3) The X-ray generating apparatus according to item 1 or 2, in which the penetration depth (D) is calculated by the following equation:

$$D = \frac{n ( a + b )}{tan θ cos ψ}$$

where n is the number of X-ray generating portions or target substrates between the plural grooves through which the X-ray excitation electrons pass (n≥1), and ψ is a tilt angle of the electron beam in a plane parallel to a surface of the target substrate.

(Item 4) The X-ray generating apparatus according to any one of items 1 to 3, in which the irradiation angle (θ) is set to a value between 10° and 75°.

(Item 5) The X-ray generating apparatus according to item 1, including an X-ray tube for phase imaging, a direction (ψ) of irradiating the electron beam for X-ray excitation inclined at a predetermined angle with respect to the perpendicular to the target substrate being set to such an angle (ψ) that 60% or more of the electron beam reaches an X-ray generating metal portion while the electron beam for X-ray excitation irradiates the target substrate and passes through an inside.

### Advantageous Effects of the Disclosure

According to the disclosure, an electron beam applied to a substrate portion is also applied to an X-ray generating portion after penetrating a substrate, and thus an X-ray can be efficiently generated.

### BRIEF DESCRIPTION OF THE DRAWINGS

FIG. 1 is an explanatory diagram for description of a generation region of an X-ray excited by an irradiated electron beam.

FIG. 2 is an explanatory diagram illustrating an X-ray tube used for an X-ray generating apparatus according to a first embodiment of the disclosure.

FIG. 3 is an explanatory diagram for description of a water cooling structure of a target used for the X-ray tube of FIG. 2.

FIG. 4 is an explanatory diagram for description of a process for manufacturing a target substrate used for the target of FIG. 3.

FIG. 5 is an explanatory diagram for description of a surface treatment process of the target substrate used for the target of FIG. 3.

FIG. 6 is an explanatory diagram for description of generation of a bremsstrahlung X-ray when the target substrate is vertically irradiated with an electron beam.

FIG. 7 is an explanatory diagram for description of generation of a bremsstrahlung X-ray when the target substrate is obliquely irradiated with an electron beam.

FIG. 8 is an explanatory diagram for description of a penetration depth of an electron beam applied to the target substrate.

FIG. 9 is an explanatory diagram for description of an irradiation direction of an electron beam to the X-ray generating portion on the target substrate.

FIG. 10 is a graph showing a relationship between voltage (kV) and an irradiation angle θ (degree) of an electron beam and a penetration depth (μm) of the electron beam into a substrate. In addition, FIG. 10(a) corresponds to a case where a substrate width b equals 1.6 μm and a width a of the X-ray generating portion equals 0.8 μm, and FIG. 10(b) corresponds to a case where the substrate width b equals 2.0 μm and the width a of the X-ray generating portion equals 1.0 μm.

FIG. 11 is a graph showing a relationship between an embedding depth M (μm) of the X-ray generating portion in the target substrate and the intensity (relative value) of the generated X-ray for each irradiation angle θ.

FIG. 12 is a graph showing a relationship between the irradiation angle θ (degree) and the intensity (relative value) of the generated X-ray for each penetration depth M (μm) of the electron beam into the substrate.

FIG. 13 is an explanatory diagram illustrating the X-ray generating apparatus incorporating the X-ray tube of FIG. 2.

FIG. 14 is an explanatory diagram for description of a two-dimensional (2D) grating structure in a target used for an X-ray generating apparatus in a second embodiment of the disclosure. FIG. 14(a) illustrates a case where the 2D grating structure corresponds to a square grating, and FIG. 14(b) illustrates a case where the 2D grating structure corresponds to a hexagonal grating.

FIG. 15 is an explanatory diagram for description of an X-ray tube used for the X-ray generating apparatus in the second embodiment of the disclosure.

### DETAILED DESCRIPTION

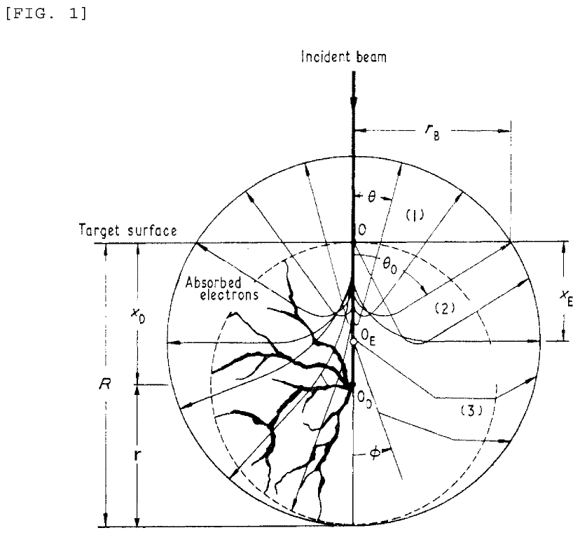

Hereinafter, embodiments for carrying out the disclosure will be described in detail with reference to the accompanying drawings. As a premise of the description of the present embodiment, first, a principle of X-ray generation by electron beam excitation will be described in detail with reference to FIG. 1.

(Principle of X-ray generation by electron beam excitation) When an electron beam is irradiated on a solid, an X-ray (characteristic X-ray) generated due to electron transition of an atom included in the solid and an X-ray generated by bremsstrahlung emitted from an electron damped by an electric field of the atom (bremsstrahlung X-ray) are generated. While an X-ray of a specific wavelength is generated as the characteristic X-ray, an X-ray of a continuous wavelength having smaller energy (longer wavelength) than maximum energy corresponding to an acceleration voltage of an electron beam is generated as the bremsstrahlung X-ray. Hereinafter, a description will be mainly focused on the bremsstrahlung X-ray.

With regard to generation of an X-ray in a solid by an electron beam applied to a surface of the solid, studies for describing a region of X-ray generation in the solid using a mathematical expression have been conducted for a long time. In particular, an equation shown in Non-Patent Document 7 is known to correspond to energy of an irradiation electron beam in a range from 10 keV to 1,000 keV. The equation presented in this thesis shows good agreement with measured values of a lot of theses reported on actual X-ray generation. FIG. 1 illustrates a model of a region of an X-ray generated inside a solid by an electron beam applied to a surface of the solid (see Non-Patent Document 7).

FIG. 1 illustrates a model in which an electron beam (incident beam) is vertically irradiated on a surface (target surface) of a solid serving as an X-ray source. In this model, electrons penetrate by a distance X_{D} from a surface O. These electrons are diffused in a spherical shape in the solid while generating X-rays, and finally absorbed by the solid. Further, a maximum penetration depth of the electrons that generate the X-rays is denoted by R. R is a distance in which an electron having energy E travels while losing energy in the solid, and is represented by the following Equation (1). Expression (2) is a result of deriving a relational expression by putting an actual numerical value into this equation. Here, E₀ denotes energy (eV) of the electron, λₛ denotes an empirical coefficient obtained from measurement, a denotes a numerical value related to an atomic radius of the solid, N denotes a numerical value expressed by N=Naρ/A, Na denotes Avogadro's number, ρ denotes the density (g/cm³) of a substance generating an X-ray, A denotes an atomic weight, and Z denotes an atomic number of the solid.

$$\begin{matrix}R = {\int }_{0}^{{E}_{0}} \frac{dE}{dE \text{/} dx} & ( 1 ) \\ = \frac{{E}_{0}^{5 \text{/} 3}}{{λ}_{8} \times 5 \times {2}^{5 \text{/} 3} π {a}^{1 \text{/} 3} {e}^{10 \text{/} 3} NZ} & ( 2 )\end{matrix}$$

When each numerical value is put in Equation (2), a relativistic correction term of energy is added, and λₛ=0.182 is set as a numerical value obtained from measurement, the following Equation (3), which is evaluated to closely match the measured value at 10 to 1,000 keV, is obtained.

$$ρ R = \frac{2 \cdot 76 \times {10}^{- 11} {AE}_{0}^{5 \text{/} 3}}{{Z}^{8 \text{/} 9}} \frac{{( 1 + 0 \cdot 978 \times {10}^{- 6} {E}_{0} )}^{5 \text{/} 3}}{{( 1 + 1 \cdot 957 \times {10}^{- 6} {E}_{0} )}^{4 \text{/} 3}} \qquad ( 3 )$$

X_{D} is expressed by the following Equation (4) using the maximum penetration depth R of the electrons. Here, γ is a value representing loss of an electron diffusion distance due to the atomic number of the target material.

$${x}_{D} = \frac{R}{1 + γ} = \frac{R}{1 + 0 \cdot 187 {Z}^{2 \text{/} 3}} \qquad ( 4 )$$

According to Equations (3) and (4), by determining the electron beam acceleration voltage (E₀), the atomic number (Z) of the element included in the X-ray target for generating the X-ray, the atomic weight (A) thereof, and the density (ρ) of the X-ray target, a region where the X-ray is generated from the solid irradiated with the electron beam can be obtained as a numerical value. Here, when a numerical value useful in designing an X-ray target shape is set to r=R−X_{D}, it can be described that an X-ray is generated in a spherical region having a radius r from the penetration distance X_{D} of electrons from the target surface.

To form a grating-shaped X-ray source, it is necessary to have an X-ray target structure in which portions having low X-ray generation efficiency and portions having high X-ray generation efficiency are alternately arranged. According to Non-Patent Document 8, the intensity Q of bremsstrahlung is represented by Expression (5). Here, P is a polynomial representing motion of an electron decelerated to the energy E.

Q(hv/E)=P(hv/E)Z²/E (5)

An important point is that the bremsstrahlung intensity is proportional to the square of the atomic number (Z) of the element serving as the X-ray target. Therefore, to form a grating-shaped radiation source, it is necessary to alternately arrange a substance including an element having a low atomic number and a substance including an element having a large atomic number.

The low atomic number elements that can be used as a material of the substrate for the X-ray target due to characteristics thereof actually correspond to Be, B, C (DI, diamond), C (DLC, diamond-like carbon), BN, SiC, AlN, etc. In obtaining a numerical value using Expressions (3) and (4), for a compound, an average atomic number and an average atomic weight are used for an atomic number and an atomic weight. Table 1 illustrates R, X_{D}, and r with respect to the electron beam energy (keV) of the above materials. Here, the unit of the numerical value is μm.

TABLE 1
Electron penetration depth by electron beam voltage for each target material and X-ray generation region

| Irradiation | | | | | | | | | | | |
|---|---|---|---|---|---|---|---|---|---|---|---|
| voltage | | Target material | | | | | | | | | |
| kV | Parameter | Be | B | C (DI) | C (DL) | BN | SiC | AlN | 2DI/W | 2SiC/W | W |
| 60 | R | 34.198 | 29.921 | 16.737 | 20.366 | 17.421 | 19.374 | 19.544 | 9.643 | 9.822 | 5.011 |
| | XD | 23.245 | 19.344 | 10.348 | 12.592 | 10.771 | 10.371 | 10.462 | 3.504 | 3.436 | 1.166 |
| | r | 10.953 | 10.577 | 6.389 | 7.775 | 6.650 | 9.002 | 9.081 | 6.139 | 6.386 | 3.845 |
| 80 | R | 54.394 | 47.591 | 26.621 | 32.394 | 27.709 | 30.815 | 31.085 | 15.337 | 15.623 | 7.971 |
| | XD | 36.972 | 30.767 | 16.459 | 20.027 | 17.131 | 16.496 | 16.641 | 5.574 | 5.466 | 1.855 |
| | r | 17.422 | 16.823 | 10.163 | 12.366 | 10.578 | 14.318 | 14.444 | 9.764 | 10.157 | 6.115 |
| 100 | R | 77.770 | 68.043 | 38.061 | 46.314 | 39.617 | 44.057 | 44.443 | 21.929 | 22.337 | 11.396 |
| | XD | 52.861 | 43.989 | 23.532 | 28.634 | 24.493 | 23.585 | 23.792 | 7.969 | 7.814 | 2.653 |
| | r | 24.909 | 24.053 | 14.530 | 17.680 | 15.123 | 20.472 | 20.651 | 13.959 | 14.522 | 8.743 |
| 120 | R | 103.970 | 90.966 | 50.885 | 61.918 | 52.964 | 58.900 | 59.417 | 29.316 | 29.862 | 15.235 |
| | XD | 70.670 | 58.810 | 31.460 | 38.281 | 32.745 | 31.532 | 31.808 | 10.654 | 10.447 | 3.546 |
| | r | 33.300 | 32.157 | 19.425 | 23.637 | 20.219 | 27.369 | 27.609 | 18.662 | 19.415 | 11.689 |
| 140 | R | 132.733 | 116.132 | 64.961 | 79.047 | 67.616 | 75.195 | 75.854 | 37.427 | 38.123 | 19.450 |
| | XD | 90.221 | 75.079 | 40.163 | 48.871 | 41.804 | 40.255 | 40.608 | 13.601 | 13.337 | 4.527 |
| | r | 42.513 | 41.053 | 24.799 | 30.176 | 25.812 | 34.940 | 35.246 | 23.825 | 24.786 | 14.923 |
| 160 | R | 163.854 | 143.360 | 80.192 | 97.581 | 83.469 | 92.825 | 93.639 | 46.202 | 47.062 | 24.011 |
| | XD | 111.374 | 92.682 | 49.579 | 60.330 | 51.605 | 49.693 | 50.128 | 16.790 | 16.464 | 5.589 |
| | r | 52.481 | 50.678 | 30.613 | 37.251 | 31.864 | 43.132 | 43.510 | 29.411 | 30.598 | 18.422 |
| 180 | R | 197.172 | 172.511 | 96.498 | 117.423 | 100.441 | 111.699 | 112.679 | 55.596 | 56.631 | 28.893 |
| | XD | 134.020 | 111.528 | 59.660 | 72.597 | 62.098 | 59.797 | 60.321 | 20.204 | 19.812 | 6.725 |
| | r | 63.152 | 60.983 | 36.838 | 44.826 | 38.343 | 51.902 | 52.357 | 35.392 | 36.819 | 22.167 |
| 200 | R | 232.554 | 203.468 | 113.815 | 138.494 | 118.465 | 131.744 | 132.899 | 65.573 | 66.793 | 34.078 |
| | XD | 158.070 | 131.542 | 70.367 | 85.624 | 73.242 | 70.528 | 71.146 | 23.830 | 23.367 | 7.932 |
| | r | 74.484 | 71.926 | 43.449 | 52.870 | 45.224 | 61.216 | 61.753 | 41.743 | 43.426 | 26.145 |
| 220 | R | 269.894 | 236.138 | 132.090 | 160.731 | 137.487 | 152.898 | 154.238 | 76.102 | 77.518 | 39.549 |
| | XD | 183.451 | 152.663 | 81.665 | 99.373 | 85.002 | 81.852 | 82.570 | 27.656 | 27.119 | 9.206 |
| | r | 86.444 | 83.475 | 50.425 | 61.359 | 52.485 | 71.046 | 71.669 | 48.445 | 50.399 | 30.343 |
| 240 | R | 309.103 | 270.442 | 151.279 | 184.081 | 157.460 | 175.109 | 176.645 | 87.157 | 88.779 | 45.295 |
| | XD | 210.101 | 174.841 | 93.529 | 113.809 | 97.350 | 93.743 | 94.565 | 31.674 | 31.059 | 10.543 |
| | r | 99.002 | 95.601 | 57.750 | 70.272 | 60.110 | 81.367 | 82.080 | 55.483 | 57.721 | 34.751 |

In the present embodiment, a 0.8 μm grating-shaped groove can be manufactured, and an N-type SiC substrate having a low resistance (up to 20 mΩ cm²) was used as a target wafer. A SiC wafer is used to form a power control semiconductor element, has high heat resistance and has been developed for a process to allow fine processing similarly to a Si wafer. However, even in the case of Be, B, C (DI, diamond), C (DS, diamond-like carbon), BN, and AlN listed in Table 1, when a conductive film for allowing a current to flow on a surface is formed using a processing process thereof, usage as a substrate for the X-ray target is similarly allowed.

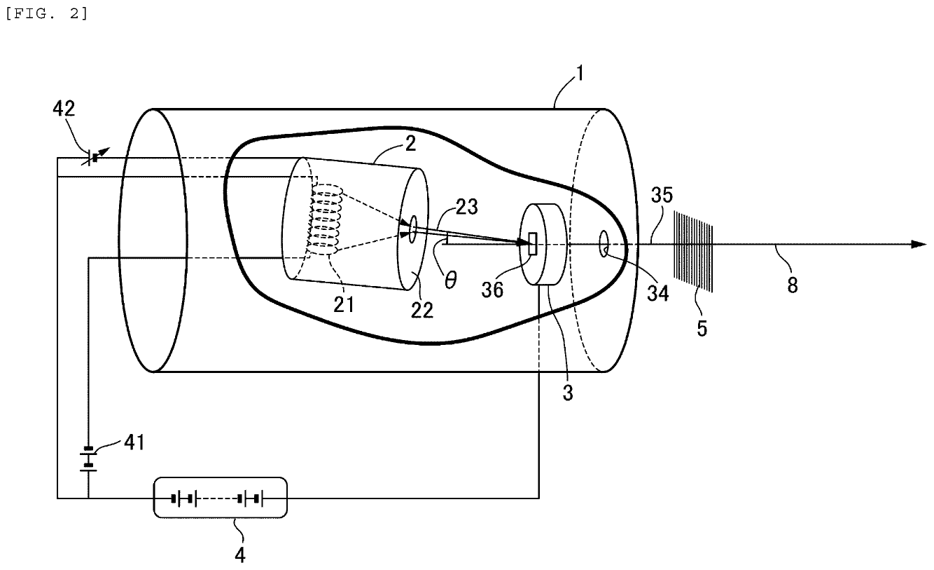

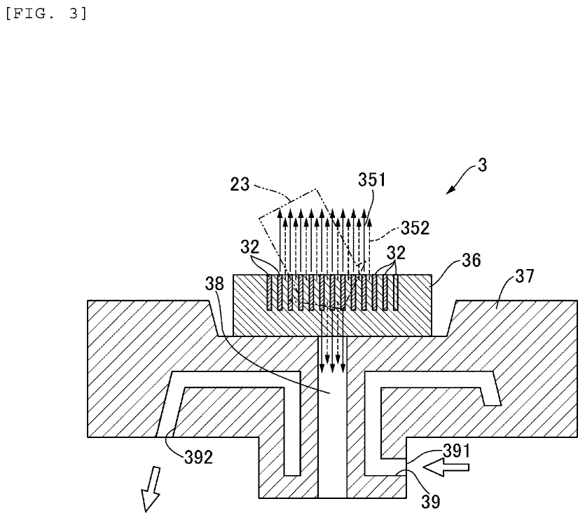

(X-ray generating apparatus of present embodiment) Next, the X-ray generating apparatus of the present embodiment (hereinafter, may be simply referred to as “generating apparatus” or “apparatus”) will be described with further reference to FIG. 2 and FIG. 3. This apparatus is for performing X-ray phase imaging using an X-ray 35 excited by an electron beam 23 applied to a target 3 from an electron source 2 (see FIG. 2). Further, this X-ray generating apparatus includes an X-ray tube body 1 that accommodates the target 3 therein, and a high-voltage power supply 4 that drives the electron source 2.

(Target) As illustrated in FIG. 3, the target 3 includes a target substrate 36 formed in a flat plate shape, X-ray generating portions 32 arranged in a grating shape on the target substrate 36, and a metal plate 37 for cooling. The target substrate 36 is made of a light element, for example, Be, B, C (DI, diamond), C (DLC, diamond-like carbon), BN, SiC, AlN, etc. In the present embodiment, it is presumed that SiC is used as the target substrate 36 unless otherwise specified. In this specification, the light element refers to an element having an atomic number of 14 or less. The target substrate 36 may be made of a substance containing a light element, and may contain an element other than the light element.

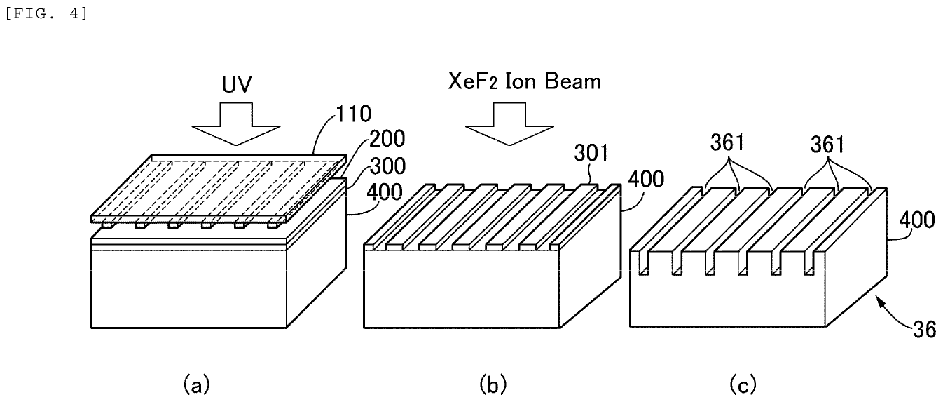

On a surface of the target substrate 36, a plurality of grooves 361 (see FIG. 4(c) described later) periodically arranged in a one-dimensional (1D) direction (right-left direction in FIG. 3) and formed in a grating shape is formed. Note that in the case of adopting a 2D grating (a second embodiment described later), the grooves 361 are periodically formed in a 2D direction.

The X-ray generating portions 32 are arranged in a grating shape by being embedded in the plurality of grooves 361 formed in the target substrate 36. Further, the X-ray generating portions 32 is made of a metal such as tungsten (W), tantalum (Ta), platinum (Pt) or gold (Au), or an alloy thereof. In the present embodiment, description will be made below on the assumption that tungsten (hereinafter sometimes referred to as W or metal W) is used.

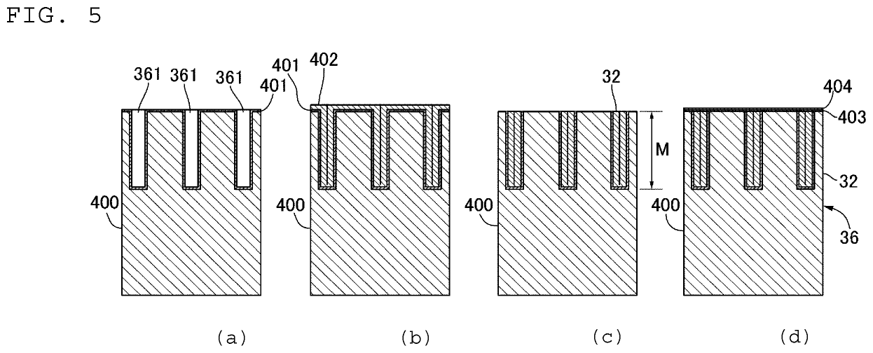

A depth M (see FIG. 5 and FIG. 8 described later) of the X-ray generating portions 32 arranged in the grating shape is set to satisfy D≤M≤D+r

Here,

r is a difference (r=R−X_{D}) between a maximum penetration depth (R) of X-ray excitation electrons irradiated as an electron beam in the X-ray generating portion and a penetration distance (X_{D}) of the X-ray excitation electrons in the X-ray generating portion; and
D is a penetration depth of X-ray excitation electrons passing through the X-ray generating portion and the target substrate in a vertical direction of the target substrate.

In the present embodiment, a ratio a:b of a grating width a of the X-ray generating portions 32 (see FIG. 8 described later) to a grating width b of the target substrate 36 is 1:2. In addition, a grating pitch a+b of the X-ray generating portions 32 is equal to or less than a penetration distance of X-ray excitation electrons passing through both the target substrate 36 and the X-ray generating portions 32, more specifically equal to or less than 10 μm.

The penetration depth D in the present embodiment can be calculated by the following equation (the same as Equation (8) described later).

$$D = \frac{n ( a + b )}{tan θ cos ψ}$$

Here,

n is the number of X-ray generating portions or target substrates between a plurality of grooves through which the X-ray excitation electrons pass (n≥1);
θ is an irradiation angle of the electron beam with respect to a perpendicular to the target substrate surface (so-called tilt angle in the period direction); and
ψ is a tilt angle of the electron beam in a plane parallel to the surface of the target substrate (so-called grating direction tilt angle).

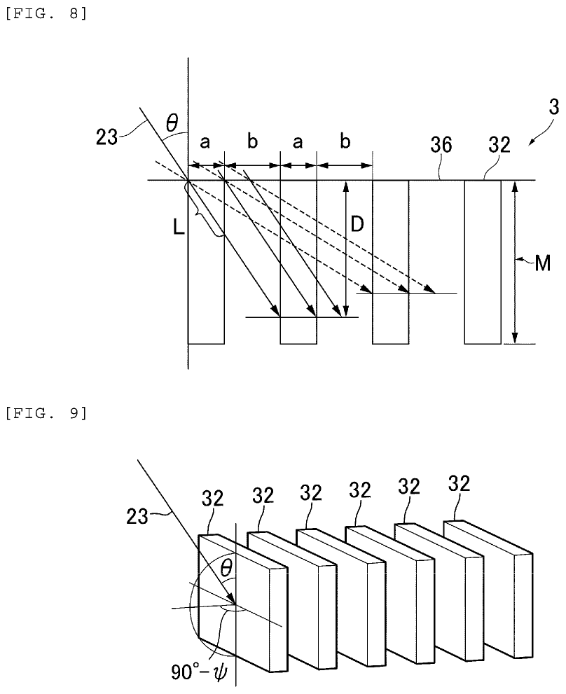

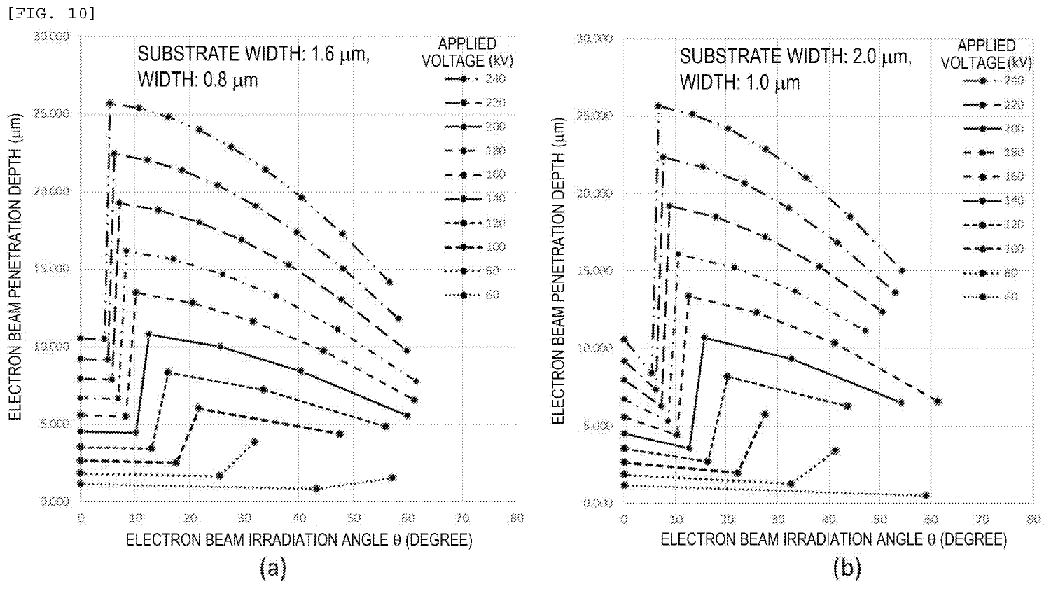

A scheme of obtaining these angles θ and ψ is illustrated in FIG. 9 described later. The angle ψ is 0° in a direction perpendicular to the surfaces of the X-ray generating portions 32.

The irradiation angle θ in the present embodiment is set to a value in a range of 10° to 75°, more preferably in a range of 15° to 65°.

The metal plate 37 has an X-ray emission hole 38 and a cooling water channel 39. The cooling water channel 39 has an inlet 391 and an outlet 392.

(Electron source) The electron source 2 is configured to be able to extract a grating-shaped X ray in a direction perpendicular to the target substrate 36 by irradiating the target 3 with the electron beam 23 inclined at a predetermined irradiation angle θ (see FIG. 2) with respect to the perpendicular to the target substrate 36. More specifically, the electron source 2 includes a filament 21 that generates electrons by applying a voltage, and an electron lens 22 that shapes an electron beam profile.

(X-ray tube body) The X-ray tube body 1 includes an X-ray extraction window 34 for extracting the X-ray beam 35 from the X-ray tube body 1.

(High-voltage power supply) The high-voltage power supply 4 includes a filament power supply 41 and a bias power supply 42.

Details of each element described above in the present embodiment will be described later as an operation of the present embodiment.

(Example of target creation method) Next, an example of a processing process for producing the target substrate 36 will be described with further reference to FIG. 4 and FIG. 5. In this processing process, a grating-shaped structure is formed on a surface of a SiC wafer 400. Specifically, first, as shown in FIG. 4(a), a SiO₂ film 300 is formed on the wafer 400, and a UV photosensitive resist film 200 is formed thereon. Subsequently, UV light is applied to the wafer 400 through a UV mask 110 having a predetermined pattern (corresponding to the grooves 361).

By developing the photosensitive resist material film 200 irradiated with the UV light, the pattern of the UV mask 110 is transferred to this film 200, and a part of the photosensitive resist material film 200 remains on the SiO₂ film 300. By dry-etching this film, only a part of the SiO₂ film 301 covered with the resist film is left, and a state illustrated in FIG. 4(b) can be obtained. In this state, dry etching using XeF₂ gas is performed using the SiO₂ film 301 as a mask, and the SiC film 301 is subjected to trench etching. In this way, as illustrated in FIG. 4(c), a grating pattern can be formed on the surface of the wafer 400. This grating pattern includes the plurality of grooves 361 formed periodically. The period direction of the plurality of grooves 361 is the right-left direction in FIG. 4(c).

Subsequently, the X-ray generating portions 32 made of metal are embedded in the wafer 400 in which the grooves 361 are formed. As described above, W (Z=74) is used as the X-ray generating portions 32 of the present embodiment. SiC is a 1:1 stoichiometric compound of Si (Z=14) and C (Z=6). According to the above Equation (5), the X-ray generation intensity from a portion W is about 47 times smaller than that of SiC. As described above, Ta (Z=73), Pt (Z=78), and Au (Z=79) can be used as the metal.

A specific embedding method of the X-ray generating portions 32 will be described with further reference to FIG. 5. First, as illustrated in FIG. 5(a), a WN film 401 is formed to have a thickness of about 2 nm on the entire surface (upper surface in FIG. 5) of the wafer 400 including the grooves 361. Subsequently, as illustrated in FIG. 5(b), a W film 402 is formed on the upper surface of the WN film 401 using a CVD method. Thereafter, as illustrated in FIG. 5(c), the W film 402 and the WN film 401 other than groove portions are removed by polishing the wafer surface. The remaining W film 402 becomes the X-ray generating portions 32. Here, the embedding depth of the W metal (that is, the X-ray generating portions 32) is represented by a symbol M.

Subsequently, a TiN film 403 and a Ti film 404 are formed on the surface formed by polishing as illustrated in FIG. 5(d). The WN film 401 and the TiN film 403 used here are barrier metals and can be omitted. The Ti film 404 serving as a metal protective film can be omitted. Further, the dimensions and materials described above are merely examples, and are not limited thereto.

(Electron beam irradiation method) Next, a description will be given of an electron beam irradiation method for efficiently extracting striped X-rays from the target 3 having the grating-shaped X-ray generating portions 32. First, a principle will be discussed below.

In the X-ray generation model illustrated in FIG. 1 described above, electrons entering the solid at a point O penetrate into the solid up to the distance of X_{D}, lose energy by diffusing while generating X-rays in a sphere of a radius r (=R−X_{D}) from a point O_{D}, are absorbed by the solid, and flow as an electric current. In this instance, the distance X_{D} and the radius r differ depending on the energy (applied voltage) of the irradiated electrons and the material (atomic number Z and density p). Numerical values obtained by the above Equation 3 and Equation 4 are shown in Table 1 described above.

The X-ray generation target according to the present embodiment is included in the X-ray source for phase imaging. In this case, it is known that a ratio of a grating width of the target substrate to a metal grating width is appropriately 2:1 (See Non-Patent Document 9 described above).

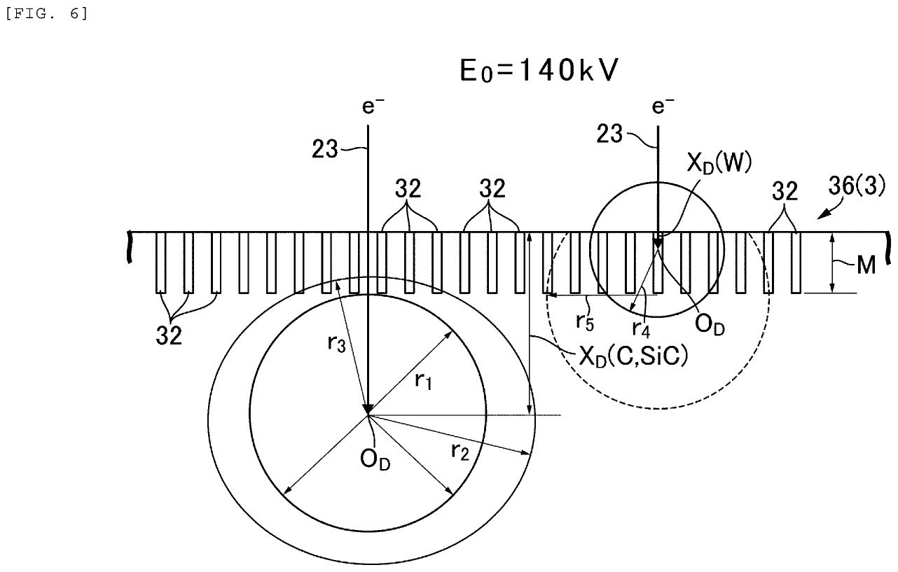

The material of the target substrate 36 is set to C (DI, diamond) or SiC, the material of the X-ray generating portions 32 is set to W, and the X-ray generation region when the target substrate 36 is perpendicularly irradiated with electrons at an applied voltage of 140 kV is illustrated in FIG. 6. It is presumed that the X-ray generating portions 32 in the target 3 are embedded in the target substrate 36 to a depth of 15 μm (that is, M=15 μm) and arranged in a grating shape.

According to Table 1, when C (DI) is used as the substrate, the electron beam vertically irradiated on the surface of the target substrate 36 (non-metal portion between the X-ray generating portions 32) generates a bremsstrahlung X-ray in a spherical region having a radius r₁ of about 25 μm around a position O_{D} at a depth of about 40 μm. In this instance, the electron beam 23 applied to the target substrate 36 does not diffuse to the X-ray generating portions 32 made of the W metal, and thus does not generate X-rays from the X-ray generating portions 32. When SiC is used as the target substrate 36, bremsstrahlung X-rays are generated from a spherical region having a radius r₂ of about 35 μm around the position O_{D} at the depth of about 40 μm similarly to C (DI). Here, a part of the electron beam 23 vertically irradiating the target substrate 36 is diffused to the X-ray generating portions 32 corresponding to the W metal. Electrons reaching the X-ray generating portions 32 by diffusion generate more bremsstrahlung X-rays from the W metal, and lose energy at a distance r₃ of about 30 μm from O_{D}.

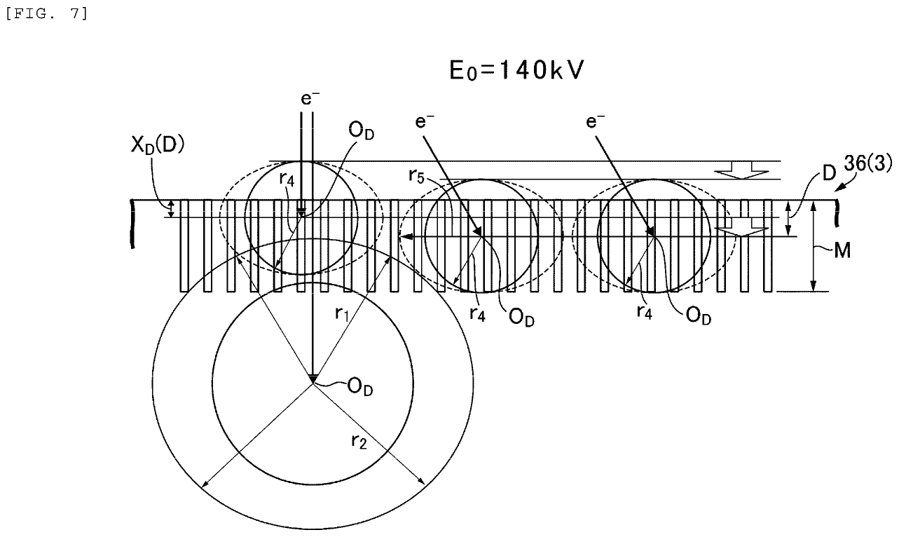

Meanwhile, the electrons applied to the surface of W corresponding to the X-ray generating portions 32 generate bremsstrahlung X-rays from a spherical region having a radius r₄ of about 15 μm around the position O_{D} at a depth of about 4.5 μm. Approximately 30 to 40% of the electrons irradiated to W corresponding to the X-ray generating portions 32 are recoil electrons and do not contribute to generation of X-rays. In addition, referring to the electrons applied to the surface of W corresponding to the X-ray generating portions 32, when the distance between the X-ray generating portions 32 is sufficiently smaller than a radius 15 μm of a braking X-ray generation region of the W metal alone, and a ratio of a width of a target substrate portion to a width of the X-ray generating portions 32 (W metal portion) is 2:1, the generation region of bremsstrahlung X-rays is widened as indicated by r of 2DI/W or 2SiC/W shown in Table 1. A radius r₅ of this generation region is larger than r₄ as illustrated in FIG. 6, and is about 24 to 25 μm. In practice, the spread of this generation region is in a direction parallel to the target substrate 36, and thus has an elliptical shape as illustrated in FIG. 7. Further, a major radius r₅ thereof is about 24 to 25 μm.

As described above, according to the principle study on the X-ray generation region illustrated in FIG. 1, when the electron beam 23 is vertically irradiated on the target substrate 36, electrons that directly irradiate the portion of the target substrate 36 made of a light element hardly reach the W metal portion. Therefore, this portion has a low rate of generating bremsstrahlung X-rays, and most of the bremsstrahlung depends on the electron beam directly irradiating the X-ray generating portions 32 (W metal portion). Therefore, in a commonly used target, for example, in the target 3 in which the ratio of the width of the target substrate 36 to the width of the X-ray generating portions 32 is 2:1, the efficiency of X-ray generation by the electron beam irradiating the target substrate 36 is low.

On the other hand, in the present embodiment, by irradiating the target 3 with the electron beam 23 inclined at a predetermined angle θ, the electron beam applied to the target substrate 36 portion generates bremsstrahlung X-rays in the X-ray generating portions (W metal portion) 32, which uses a characteristic in which the material of the target substrate 36 has a longer electron penetration distance X_{D} of the incident electron beam than that of the metal portion (for example, W), and the electron beam irradiated on the target substrate 36 can be transmitted longer through the target substrate material. Hereinafter, this point will be described in more detail.

An explanatory diagram of a depth D from a surface into which the electron beam 23 passing through the X-ray generating portions 32 (W metal grating) having the width a and the target substrate 36 portion having the width b (hereinafter may be indicated by a symbol “K”) can penetrate is illustrated as FIG. 8. In FIG. 8, a symbol θ denotes an irradiation angle (incident angle) of the electron beam on the X-ray target 3. A symbol L is set to a distance in which the electron beam 23 passes through the X-ray generating portions 32 (W metal portion). When the distance L is shorter than the electron beam penetration distance X_{D}(W) in the X-ray generating portions 32 (W metal portion), the electron beam irradiated on the X-ray generating portions 32 (W metal portion) passes through the X-ray generating portions 32 (W metal portion) and penetrates the target substrate portion. When a minimum angle allowing penetration in this way is set to θₘᵢₙ, θₘᵢₙ is expressed by Equation (6) below. In Equation (6), a symbol ψ denotes an angle formed between the electron beam 23 and wall surfaces of the X-ray generating portions 32 (W metal) (tilt angle in a plane parallel to the surface of the target substrate 36) as illustrated in FIG. 9.

$$sin {θ}_{min} = \frac{a}{{X}_{D} ( W ) cos ψ} \qquad ( 6 )$$

Similarly, the electron beam 23 incident on the target substrate 36 portion illustrated in FIG. 8 passes through the target substrate 36 portion and penetrates the X-ray generating portions 32 (W metal portion).

By irradiating the X-ray generating portions 32 with the electron beam at an angle equal to or greater than θₘᵢₙ, bremsstrahlung X-rays can be generated to a deeper portion when compared to the case of irradiating the W metal alone (case of θ=0°). Further, in the present embodiment, the X-ray generating portions 32 can generate bremsstrahlung X-rays using the electron beam incident on the target substrate 36 portion. Here, a condition when transmitting the X-ray generating portions 32 and substrate portions (portions adjacent to the X-ray generating portions 32) by a length of n sheets is expressed by the following Equation (7). In addition, the electron beam penetration depth D is represented by the following Equation (8). Here, n≥1.

$$\begin{matrix}n [ \frac{a}{{X}_{D} ( W )} + \frac{b}{{X}_{D} ( K )} ] = sin θ cos ψ & ( 7 ) \\ D = \frac{n ( a + b )}{tan θ cos ψ} & ( 8 )\end{matrix}$$

In the above Equations (7) and (8), under the condition that n is an integer, regardless of the position of the electron beam applied to the X-ray generating portions 32 (W metal portion) of the X-ray target and the target substrate 36 portion, the penetration depth is the same. When n is a non-integer value of 1 or more, the penetration depth of the electron beam irradiated on the X-ray generating portions 32 (W metal portion) becomes smaller than the penetration depth of the electron beam irradiated on the target substrate 36 portion. However, the average of the penetration depth in the entire electron beam irradiation portion including the substrate 36 portion and the X-ray generating portion 32 (W metal portion) is substantially the same as a value obtained by Equations (7) and (8).

In addition, to achieve irradiation of an electron beam in which n becomes 1 or more, it is necessary that the electron beam penetrates at least up to a length corresponding to one period of the grating pitch. Under this condition, a maximum length of the grating pitch (a+b) of the X-ray target 3 can be determined. A maximum value Pₘₐₓ of the grating pitch (a+b) when the ratio of the width of the X-ray generating portions 32 (W metal portion) to the width of the SiC target substrate 36 portion is 1:2 and n=1 is shown for each electron beam energy in Table 2 below.

TABLE 2
Maximum value of grating pitch (a +
b) with respect to applied voltage

Unit (μm)

| Applied voltage (kV) | X_{D} (W) | X_{D} (K) | a + b |
|---|---|---|---|
| 60 | 1.166 | 10.371 | 2.856 |
| 80 | 1.855 | 16.496 | 4.543 |
| 100 | 2.653 | 23.585 | 6.497 |
| 120 | 3.546 | 31.532 | 8.685 |
| 140 | 4.527 | 40.255 | 11.087 |
| 160 | 5.589 | 49.693 | 13.688 |
| 180 | 6.725 | 59.797 | 16.470 |
| 200 | 7.932 | 70.528 | 19.426 |
| 220 | 9.206 | 81.852 | 22.546 |
| 240 | 10.543 | 93.743 | 25.821 |

Here, in the present embodiment, the grating pitch (a+b) is set to be equal to or less than the penetration distance X_{D} of the X-ray excitation electrons passing through both the target substrate 36 and the X-ray generating portions 32 as described above. That is, the grating pitch (a+b) is set to a narrow distance enough to allow the X-ray excitation electrons to pass through both the target substrate 36 and the X-ray generating portions 32.

The actually employable grating pitch (a+b) is determined by the electron beam irradiation angle θ and a number n based on that the electron beam penetrates up to a length corresponding to n times the grating pitch, and is determined by the following Equation (9). Here, it is presumed that ψ=0°. In addition, Pₘₐₓ is a maximum value of the grating pitch.

$$a + b = \frac{{P}_{max}}{n} sin θ \qquad ( 9 )$$

According to Equation (9), 0≤sin θ≤1 from a range of θ that can be actually taken, and therefore, the maximum value of the grating pitch of the X-ray target is present. The Pₘₐₓ when the applied voltage is 240 kV is about 26 μm. However, considering the general applied voltage (140 kV) and the irradiation angle θ of the electron beam (usually less than 90°), it is desirable that a+b≤10 μm.

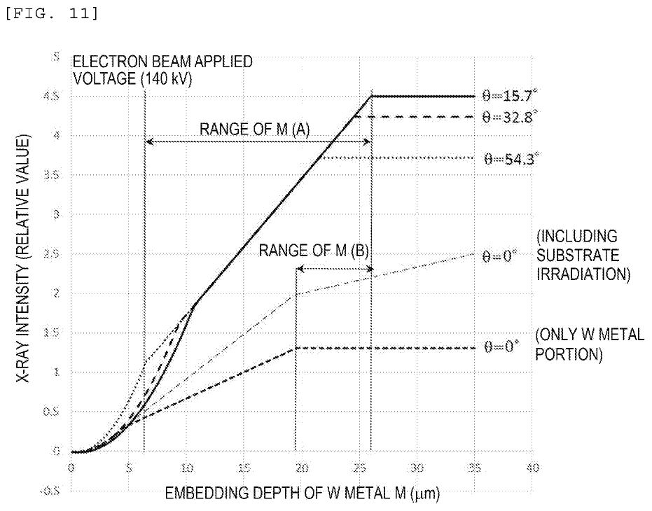

In the present embodiment, a tilt direction of the electron beam irradiation on the X-ray target (that is, on the W metal pattern) is perpendicular to the surface of the X-ray generating portions 32 (that is, ψ=0°) in projection onto the surface of the X-ray generating portions 32 (see FIG. 9). FIG. 10 illustrates a result of calculating the electron beam penetration depth D with respect to the electron beam irradiation angle θ based on Equations (7) and (8) when the material of the X-ray generating portions 32 is set to the W metal, the material of the target substrate is set to SiC, ψ=0°, a=0.8 μm and b=1.6 (FIG. 10(a)), and a=1.0 μm and b=2.0 μm (FIG. 10(b)). In the example of 140 kV, when θ is set to be larger than the angle of θₘᵢₙ (=10.2 degrees), the penetration distance X_{D} of the electron beam in the W metal alone (that is, ψ=0°) is about 4.5 μm. However, in a range of 10.2 to 25.6 degrees, the penetration distance X_{D} can be set to 10 μm or more, and the entire irradiation electron beam can be utilized for X-ray generation by the X-ray generating portions 32 (W metal portion). Therefore, depending on the actual design of the electron beam optical system, the irradiation angle θ of the electron beam irradiation is suitably in a range from 10° to about 75° at which D can be made approximately equal to X_{D}(M).

In the present embodiment, since the irradiation electron beam 23 is inclined, the electron beam 23 incident on the X-ray generating portions 32 (W metal portion) passes through the X-ray generating portions 32 (W metal portion), and penetrates the target substrate 36 made of a light element. For this reason, the electron beam penetration depth D from the substrate surface becomes deeper than that in the case of the metal W alone. In addition, the electron beam 23 incident on the target substrate 36 made of a light element passes through the target substrate 36 portion, and then enters the X-ray generating portions 32 (W metal portion). Thus, also in this case, the electron beam penetration depth D is deeper than in the case of the metal W alone. Then, in the target 3 including the target substrate and the metal portion, a portion generating the braking X-ray can be located deep from the surface, and the volume of a braking X-ray generating spherical region can be increased. Then, when compared to a case where the electron beam 23 is irradiated perpendicularly to the target substrate 36 (θ=0°), the intensity of X-ray generation is increased.

When the penetration depth (D) of a 140 kV electron beam 23 can be changed from 4.5 μm to 10 μm, the volume for generating the braking X-ray increases by about 20% when the X-ray generating portions 32 correspond to the W metal. In the case of vertical irradiation (θ=0°), a maximum length R (=X_{D} r) in the depth direction as a distance for generating bremsstrahlung X-rays in the W metal portion is about 20 (X_{D}(W) of FIG. 6=4.5 μm, r₄=15 μm). On the other hand, in the case of oblique irradiation in the range of θ=10.2 to 25.6 degrees, the length R is about 25 μm (here, R=D+r₄; D≈10 μm, r₄ 15 μm). Therefore, when the embedding depth M (see FIG. 8) of the X-ray generating portions 32 (W metal portion) is up to the depth r at which the electrons generating the bremsstrahlung X-rays are diffused, all the electron beams can contribute to generation of X-rays in the X-ray generating portions 32 by obliquely irradiating the electron beam. Therefore, by obliquely irradiating the electron beam, it is possible to generate more braking X-rays from the X-ray generating portions 32 (W metal portion) than in the case of vertical irradiation.

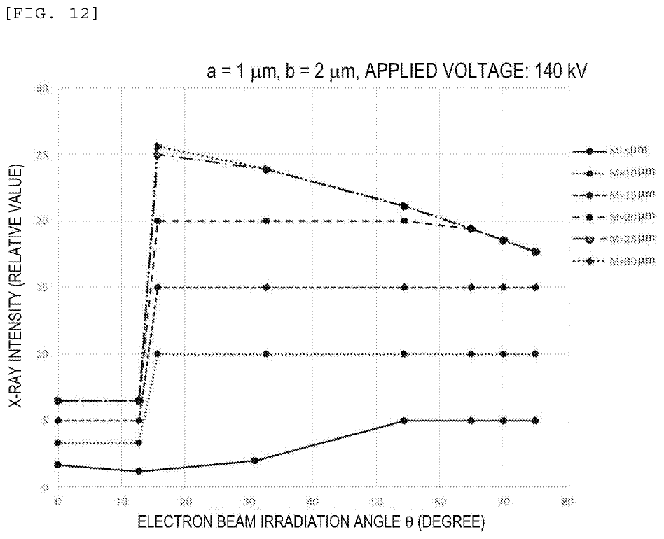

Next, a relationship between the depth of the X-ray generating portions 32 (W metal portion) that mainly generate X-rays and the intensity of the emitted X-rays will be considered with reference to FIG. 11. Here, the applied voltage of the electron beam is set to 140 kV, the width a of the X-ray generating portions 32 (W metal portion) is set to 1 μm, and the width b of the target substrate portion is set to 2 (that is, corresponding to FIG. 10(b)). The electron beam irradiation angle θ is calculated using the case of vertical irradiation (θ=0°) and the case of setting n to 1, 2, and 3 in the above Equations (7) and (8) (corresponding to θ=15.7°, 32.8°, and 54.3°). In addition, ψ is set to 0°.

In the vertical irradiation, the electron beam that does not irradiate the X-ray generating portions 32 reaches a depth corresponding to the penetration distance X_{D}(K) in the target substrate 36, and the electrons generating X-rays diffuse from this location. A case where the applied voltage of the electron beam is set to 140 kV, and M is smaller than the depth (4.527 μm) of the penetration distance X_{D}(W) into W, that is, M<X_{D}(W) is taken as an example. Here, when the target substrate 36 is SiC, as can be seen from Table 1, the penetration distance X_{D}(K) at the target substrate 36 is 40.255 μm, and the diffusion limit r(K) (=R−X_{D}) is 34.940 μm. Therefore, when M is 5.315 μm or less, which is a difference between the penetration distance X_{D}(K) and the diffusion limit r(K), the electrons of the electron beam vertically irradiated on the target substrate do not reach the X-ray generating portions 32, and thus X-rays are not generated due to the electrons.

Meanwhile, the electron beam irradiating the X-ray generating portions 32 penetrates the W metal as the X-ray generating portions 32, so that a penetration distance in the depth direction of the target substrate 36 decreases. That is, in this case, even when M<X_{D}(W), X-rays are generated from the X-ray generating portions 32. In addition, in the case of X_{D}(W)≤M≤X_{D}(W)+r(W), which corresponds to a range (A) of M of FIG. 11 described later, the X-ray intensity increases linearly with respect to M. Meanwhile, when the depth M of the W metal is X_{D}(K)−r(K)>0, which is a case where M of FIG. 11 described later corresponds to 5.315 μm or more, the electrons penetrating to X_{D}(K) by vertically irradiating the target substrate 36 with an electron beam (that is, θ=0), diffuse inside the target substrate material and reach the X-ray generating portions 32 to generate bremsstrahlung X-rays. For this reason, when the grating pitch (a+b) of the X-ray target is a value sufficiently smaller than Equation (9), the intensity of X-rays generated under the electron beam vertical irradiation condition is the X-ray intensity at θ=0° (including the case of irradiating the substrate) in FIG. 11. Note that here, “θ=0° (including the case of irradiating the substrate)” means that X-rays excited by electrons diffused by irradiating the substrate are taken into consideration.

Next, a case where θₘᵢₙ≤θ, M is sufficiently large, and an electron beam can pass through both the X-ray generating portions 32 and the target substrate 36 will be considered. When the target is irradiated with an electron beam at θ=15.7°, the penetration depth D of the electron beam is 10.7 μm from Equation (8). When θ is the same, the penetration depth D is the same in the case of the electron beam irradiating the target substrate 36 and in the case of the electron beam irradiating the X-ray generating portions 32. Here, when M is equal to or greater than the penetration depth D, all the electrons diffusing into the X-ray generating portions 32 involve in generation of the braking X-ray.

The value of D differs depending on the irradiation angle of the electron beam. When the applied voltage is 140 kV, D=9.3 μm at θ=32.8° and D=6.5 μm at θ=54.3°. Therefore, in the oblique electron beam irradiation, a state such as direct irradiation of the target substrate in the case of vertical irradiation (a state in which a lot of electrons do not contribute to X-ray generation and the efficiency is low) does not occur. That is, all the irradiated electron beams contribute to the generation of X-rays from the W metal. However, when M>D+r(W), there is no electron diffusion that contributes to X-ray generation even when M is increased, and thus the X-ray intensity is saturated at M=D+r(W). FIG. 11 described above illustrates an example of calculation of the depth M of the X-ray generating portions 32 (W metal portion) from the surface of the target substrate 36 and the bremsstrahlung X-ray intensity. These calculations take into consideration the X-rays generated by reaching the X-ray generating portions 32 (W metal portion) by the diffusion of the electron beam penetrating the target substrate 36 and the volume of the X-ray generating portions 32 generating X-rays by penetration of the irradiated electron beam. However, absorption of X-rays generated by the electron beam by the X-ray generating portions 32 and the substrate material is generally not considered since the absorption is small.

The electrons penetrating the target substrate 36 due to the vertical irradiation of the electron beam reach the depth X_{D}(K) along a penetration direction of the electrons, and then diffuse inside the target substrate 36 within the range of r(K). Thus, in the case of M>X_{D}(K)−r(K), the electrons reach the X-ray generating portions 32 and generate bremsstrahlung X-rays. For this reason, when the grating pitch (a+b) of the target 3 is a value sufficiently smaller than a+b obtained by Equation (9), the X-ray intensity generated under the condition that the electron beam is vertically irradiated becomes the X-ray intensity at θ=0° including the substrate irradiation in FIG. 11. Even in consideration of this effect, in the present embodiment, by generating X-rays using an inclined irradiation electron beam, the efficiency of generating X-rays from a grating-shaped X-ray target can be improved when compared to a method of vertically irradiating an electron beam. In the case of manufacturing a target by embedding a metal grating in the target substrate 36, increasing the embedding depth M increases the technical difficulty of manufacturing. For this reason, it is desirable that the embedding depth M is as small as possible. When the embedding depth M is made as deep as the penetration depth of the electron beam into the substrate (depth in the penetration direction of the electron beam) X_{D}(K), the X-ray generation efficiency can be improved even using a method of vertically irradiating the electron beam. However, such processing is practically difficult in terms of processing cost.

On the other hand, in the present embodiment, when D determined by Equation (8) depending on the irradiation angle (that is, the depth in the direction perpendicular to the substrate surface) is used, the embedding depth M is excellent in X-ray generation efficiency under the same applied voltage and current conditions in the range of D≤M≤D+r(W) (range (A) of FIG. 11). In particular, in the range from X_{D}(W)+r(W) to D+r(W) (range (B) of FIG. 11), X-rays can be generated most efficiently with respect to the embedding depth M of the X-ray generating portions 32. When M exceeds D+r(W), increasing the embedding depth M does not contribute to the X-ray generation efficiency. However, difficulty of manufacturing increases. Therefore, it is preferable that M≤D+r(W). From the above description, it is understood that D≤M≤D+r(W) is preferable. More preferably, X_{D}(W)+r(W) M D+r(W).

A relationship between the electron beam irradiation angle θ and the X-ray intensity shown in FIG. 11 is shown in FIG. 12 for each value of M. As can be seen from these values, when the value of M is equal to or larger than a certain value (when M≥10 μm in the example of FIG. 12), the X-ray intensity can be increased at about 10°≤0. However, when the value of θ is excessively large, the electron beam is irradiated almost in parallel to the substrate surface. Thus, when the energy of the electron beam is constant, X_{D}(W) decreases, and the ratio of recoil electrons increases. For this reason, it is preferable that θ≤about 75°. It is more preferable that θ≤65°.

(Operation of target) Next, an operation of the target 3 irradiated with the electron beam 23 will be described with reference to FIG. 3. When the 140 kV electron beam 23 is irradiated at an angle θ (see FIG. 9) on the target substrate 36 made of SiC (here, ψ=0°), the electron beam reaches a maximum depth of about 75 μm from the surface in the SiC portion (Refer to R=75.195 μm of Table 1), and heat is generated by decelerating while radiating a bremsstrahlung (small intensity) X-ray 352. In addition, in the X-ray generating portions 32 (W metal portion), the electron beam reaches a maximum depth of about 25 μm, and loses energy while radiating a bremsstrahlung (large intensity) X-ray 351 to generate heat. In other words, in this case, a maximum depth at which the electrons penetrate is 25.6 μm since X_{D}(W) is 10.67 μm and r(W) is 14.92 μm when θ=15.7 degrees. Therefore, it is necessary to provide a structure that efficiently removes heat generated at a depth of 75 μm from the surface. In a conventionally known example that is not a rotating anode (see Patent Documents 1, 5 to 7, etc. described above), it is intended to avoid the problem of heat generation of the target by reducing the thickness of the target and reducing the amount of electron beam energy absorbed by the target.

In the present embodiment, the target substrate 36 is electrically and thermally bonded to the water-cooled metal plate 37 by metal bonding. Assuming that the thermal conductivity of the N-type SiC included in the target substrate 36 is 150 W/mK, even in a case where 1 kW of heat is generated on a front surface portion, when a temperature difference is obtained based on Fourier's law by approximating with 1D heat conduction in the case of removing heat from a back side, a temperature difference between a front and a back of the target substrate 36 becomes about 80 to 90° C. Aluminum (Al) or copper (Cu), which is a common metal material used for the water-cooled metal plate 37, has a thermal expansion coefficient of 16 to 23 ppm, which is larger than 3.7 ppm for a SiC wafer and 4.5 ppm for the W metal. Thus, metal bonding may not be sufficiently performed. Furthermore, there is a possibility that a joint between the substrate 36 and the metal plate 37 is broken or the SiC wafer is broken due to the thermal stress caused by turning ON/OFF the electron beam power. Thus, in the present embodiment, as the material of the substrate 36, it is possible to use a material in which aluminum and Si fine particles are thermally compressed to suppress the thermal expansion coefficient. Since the thermal conductivity of this material is 150 W/mK and the thermal expansion coefficient is about 7 ppm, a structure that reduces thermal stress can be realized.

In the present embodiment, the maximum surface temperature of the substrate 36 is maintained at about 200° C. or less by using the SiC target substrate 36, setting the cooling water temperature to 20 to 30° C., and setting maximum power of the applied electron beam to about 2 kW. In this way, it is possible to suppress damage to an embedding structure of the fine X-ray generating portions 32. For cooling an X-ray tube loaded with an electron beam load of 2 kW, a water-cooled cooling system having a proven track record in cooling X-ray diffraction tubes is commercially available. By circulating the cooling water using this cooling system, the target 3 can be stably cooled. When this cooling method is used, an X-ray tube using an electron beam to which power of 2 kW or more is applied can be realized depending on the irradiation diameter of the electron beam 23 and the design of the cooling system. Note that in the present embodiment, the cooling method using water cooling is described. However, as a cooling method, it is possible to use not only water but also liquid cooling using oil or liquid metal as a refrigerant, or an air cooling system using gas.

In the water cooling structure of FIG. 3, the X-ray emission hole 38 having a diameter of 1.5 mm is provided on the side of the target substrate 36 where the X-ray generating portions 32 are not provided (back side). It is optimal to take out the X-rays in a direction perpendicular to the surface in which the X-ray generating portions 32 are embedded. However, in the case of extracting X-rays of 25 keV or more, even when SiC having a thickness of 330 μm is used as the target substrate 36, the decrease in X-ray intensity due to the X-ray absorption of the substrate 36 is not greatly large. Therefore, in this case, extracting from the back surface of the substrate 36 is practically possible. Note that when X-rays are extracted only from the surface direction of the substrate 36, the X-ray emission hole 38 is unnecessary, and this configuration is advantageous in terms of cooling.

(X-ray tube) Here, the X-ray tube for phase imaging in which the above-described target 3 is installed will be described in more detail with reference to FIG. 2.

This X-ray tube is of a type that extracts X-rays from the back surface of the target substrate 36. The electron source 2 in which the filament 21 for generating thermoelectrons and the electron lens 22 are disposed inside the X-ray tube body 1 whose inside is evacuated to a high vacuum. The X-ray target 3 having a pattern of the X-ray generating portions 32 on a surface is installed to face the electron source 2. The tilt angle of the electron beam 23 irradiating the surface of the target 3 is set to a predetermined angle θ. A cross-sectional shape of the thermoelectrons generated by the filament 21 heated by the filament power supply 41 is adjusted by the bias power supply 42 and the electron lens 22, and the thermoelectrons are accelerated by a high voltage of the high-voltage power supply 4 to irradiate the X-ray target 3. The electron beam irradiates the target substrate 3 at a predetermined tilt angle θ from an oblique direction, and the electron beam penetrates to a predetermined depth from the target surface by the acceleration voltage of the electrons.

The X-ray target 3 of the present embodiment is water-cooled, and thus desirably set to a ground potential together with the X-ray tube body 1. By setting the target potential to the ground potential, it is possible to reduce a distance between the target substrate 36 and the X-ray extraction window 34 attached to the X-ray tube body 1. Further, in the Lau interferometer proposed in Non-Patent Document 6, it is necessary to install the target substrate corresponding to G0 and the phase grating G1 at a short distance. However, in the X-ray tube of the present embodiment, it is possible to establish a Lau interferometer by disposing a phase grating 5 disposed outside the X-ray extraction window 34 near the target substrate 36.

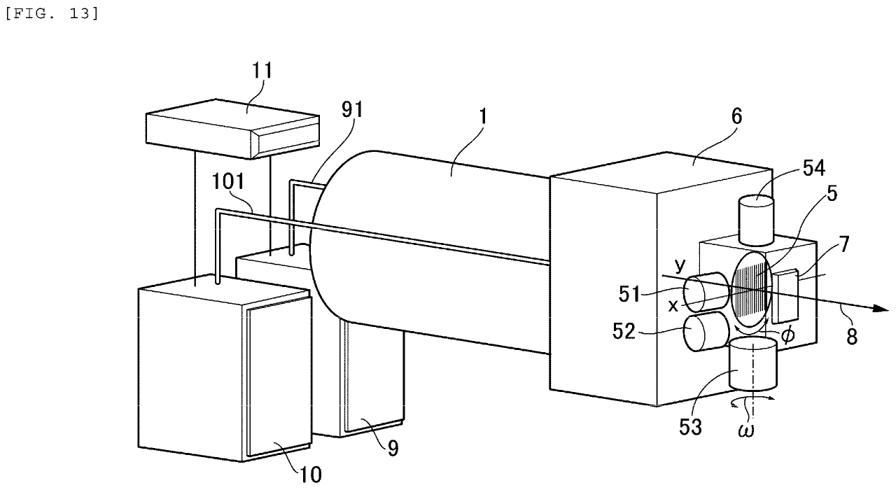

In the present embodiment, the target substrate 36 and the phase grating 5 can be disposed close to each other, so that the X-ray tube ball body 1 and the phase grating 5 can be integrally coupled to each other. FIG. 13 illustrates an overall configuration example of the X-ray generating apparatus incorporating the above-mentioned X-ray tube. In this system, the X-ray tube housing 6 is mounted on the X-ray tube body 1, and cooling water of the X-ray target 3 is supplied from the water cooling apparatus 10 through the cooling water pipe 101 and the X-ray tube housing 6. The phase grating 5 is placed on the X-ray tube housing 6, and the phase grating ϕ rotation driving apparatus 52 is attached to the phase grating 5. In this way, rotation of the phase grating ϕ around a y-axis which is a traveling direction (main axis direction) of a phase imaging X-ray 8 can be adjusted so that the grooves 361 of the X-ray target and the X-ray generating portions 32 are parallel to a grating member of the phase grating 5. Further, this system is provided with a phase grating y-axis driving apparatus 54 and a phase grating ω-axis driving apparatus 53. The phase grating y-axis driving apparatus 54 adjusts an interval (distance in a y-axis direction) between the X-ray target corresponding to the grating G0 as the Lau interferometer and the phase grating 5 corresponding to the grating G1. In addition, the phase grating ω-axis driving apparatus 53 adjusts parallelism of the phase grating 5 with the X-ray target and a tilt angle from the parallel (that is, rotation about a Z-axis). The Z-axis is set in parallel with the longitudinal direction of the grating of the X-ray target (direction orthogonal to the periodic direction of the grating within the grating plane). Further, a phase grating x-axis driving apparatus 51 is provided so that a relative position can be changed (that is, translated in an X-axis direction) in a short-axis direction of the grating (that is, the periodic direction of the grating) while maintaining parallelism between the X-ray target 3 and the phase grating 5.

A power supply apparatus 9 includes the high-voltage power supply 4, the filament power supply 41, and the bias power supply 42, and can supply a necessary voltage to the electron source 2 via a cable 91.

A control apparatus 11 can dynamically control operation timing and operation content of the water cooling apparatus 10 and the power supply apparatus 9 in accordance with preset content or in response to a detection result from an appropriate sensor (not illustrated).

As described above, in the present embodiment, a embedding depth of an X-ray target having a structure in which a metal is embedded in a target substrate made of a light element serving as a support substrate has been studied. A range of arrival (R), a penetration depth (X_{D}), etc. of electrons irradiated on the substrate and the X-ray generating portions 32 as the electron beam are studied in detail, and it is possible to obtain optimum ranges of a depth of the metal pattern irradiated with the electron beam and an irradiation angle on the target wafer on the side where the pattern is formed to increase the X-ray dose generated from the metal pattern.

From a result of study of the range of arrival (R) and the penetration depth (X_{D}) of the irradiated electron beam in the target, in a case where W is used as metal embedded in the substrate, it is desirable that the irradiation angle (θ) on the target wafer satisfies a condition of sin θ>a/X_{D} with respect to the width (a) of W. X_{D} changes with the irradiated electron beam energy (E, acceleration voltage). For example, when E=140 kV, the minimum θₘᵢₙ=10.2 degrees when a=0.8 μm. The most desirable angle is θ=12.5 degrees. In this instance, the optimum embedding depth (M) of the X-ray generating portions 32 generating bremsstrahlung X-rays is 26.7 μm. After the numerical values are determined in this way, grooves having a width of 0.8 μm can be formed at a pitch of 2.4 μm on the surface by a semiconductor/MEMS process, for example, by a plasma etching process using XeF₂ gas using a low-resistance (up to 20 mΩ cm²)N-type SiC substrate as a target wafer. After depositing W using the CVD method on a wafer having grooves formed in a grating shape and filling the grooves with W metal, the W metal at a position other than in the grooves on the target wafer is removed by polishing, so that a target wafer in which a grating-shaped W metal is embedded can be manufactured.

### Second Embodiment

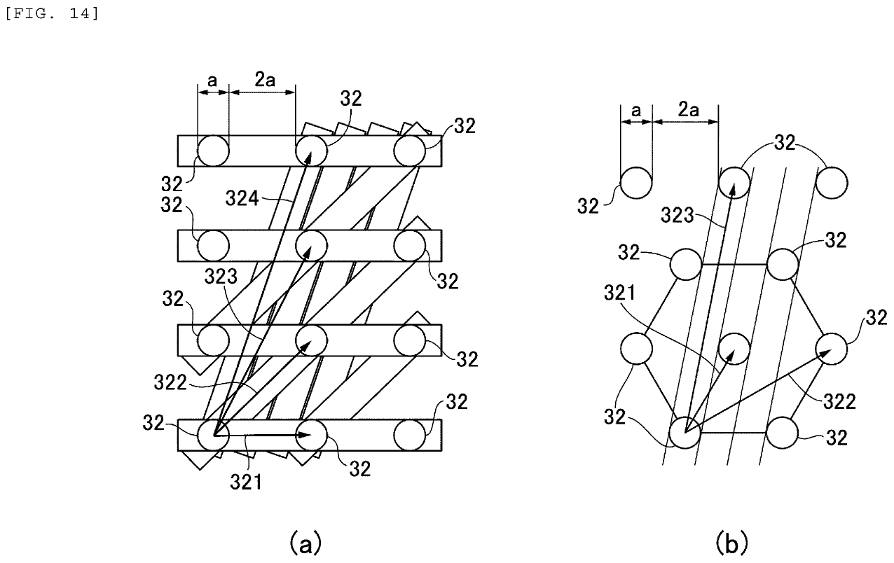

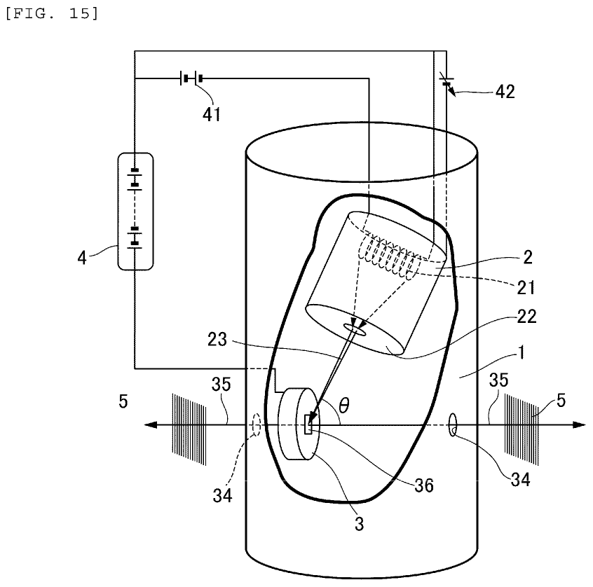

Next, an X-ray generating apparatus according to a second embodiment of the disclosure will be described with reference to FIG. 14. In the apparatus of the first embodiment described above, the X-ray target 3 in which the X-ray generating portions 32 having a linear pattern having a 1D periodic direction is embedded in the target substrate is used. On the other hand, in the apparatus of the second embodiment, grooves 361 are formed on a surface of a target substrate 36 so as to have a 2D periodic direction (that is, to have a 2D pattern), and X-ray generating portions 32 are embedded in the grooves 361. In this way, X-rays of a 2D pattern can be extracted. However, in FIG. 14, the illustration of the substrate is omitted, and only the circular X-ray generating portions 32 are illustrated. Note that D and M in the second embodiment can be the same as those in the case of the first embodiment.

In the 2D pattern, regular repetition in a 2D direction is required. As an example of realizing such a 2D pattern, the present embodiment considers two types corresponding to a case where the number of closest grating points from a certain grating point is four (FIG. 14(a): Example 1) and a case where the number is six (FIG. 14(b): Example 2). When the number of closest grating points is four as illustrated in FIG. 14(a), a 2D pattern of a square grating is obtained. When the number of closest grating points is six as illustrated in FIG. 14(b), a 2D pattern of a hexagonal grating is obtained. Here, in each of the examples, the shape of each grating point is set to a circular shape having a diameter a (a circular shape when viewed from the X-ray irradiation direction), and a distance of 2a is provided between the grating points. Therefore, the pitch between the gratings is a+2a=3a. In this instance, when the target substrate is vertically irradiated with an electron beam (that is, irradiated in a direction perpendicular to the plane of FIG. 14), the area occupancy of the X-ray generating portions 32 in the case of the square grating (Example 1) is about 8.7%. That is, about 8.7% of the irradiated electron beam directly irradiates the X-ray generating portions 32 to excite X-rays, and about 91% of the electron beam directly X-ray excites only the light element target substrate. Similarly, in the case of the hexagonal grating (Example 2), the area occupancy of the X-ray generating portions 32 is about 10%. Therefore, about 10% of the irradiated electron beam directly X-ray excites the X-ray generating portions 32.

When the electron beam is inclined in a first approaching direction 321 (FIG. 14(a)), the electron beam X-ray excites the W metal in a part of a column of grating points having the width a. However, in the case of the square grating, electrons irradiating a target substrate portion having a width 2a (about 67% of the whole) do not directly X-ray excite the W metal. Even in this case, when compared to the electron beam vertical irradiation, the electron beam irradiating the X-ray generating portions 32 is increased by about 3.3 times. Therefore, it is possible to increase X-ray excitation of the X-ray generating portions 32 by about 3.3 times. In the case of the square grating, when the irradiation direction of the X-ray is changed to a second approaching grating point direction 322, a third approaching grating point direction 323, and a fourth approaching grating point direction 324, the X-ray generating portions 32 are not X-ray excited in a portion of a width of about 1.1a (about 37% of the whole) in the case of the second approaching grating point direction and a portion of a width of about 0.34a (about 11% of the whole) in the case of the third approaching grating point direction. On the other hand, in the fourth approaching direction, gratings having the diameter a overlap on the projection plane, and the X-ray generating portions 32 are excited using all the electron beams. In this way, the X-ray intensity about 11 times as high as that of the vertical irradiation can be obtained. A distance between grating points in the fourth approaching is 3×(10a)^{1/2}, and a distance between grating points in the case of a=1 μm is about 9.5 μm. Note that in the present embodiment, an angle at which ψ is in the second approaching grating point direction (or the third or fourth approaching grating point direction) corresponds to an example of “such an angle that 60% or more of the electron beam reaches an X-ray generating metal portion while an electron beam for X-ray excitation irradiates the target substrate and passes through the inside”. When ψ is in the second approaching grating point direction, the electron beam reaches the X-ray generating metal portion 32 by about 63%. The X-ray generation efficiency can be improved by increasing a ratio of the electron beam reaching the X-ray generating metal portion 32.

Here, since the metal grating is closest to the first approaching direction, this direction is considered in the same way as the direction of the metal grating of the 1D grating, and the angle ψ is taken as FIG. 14a. When the applied voltage of the electron beam for X-ray excitation is 140 kV, a=1 μm and b=8.5 μm from a distance between gratings in the fourth approaching. Therefore, when calculation is performed based on Equation (7) and Equation (8), θ=27.1°, ψ=18.4°, and the depth D=about 19.6 μm are obtained in the case of n=1. In the case of n=2, θ=65.6°, ψ=18.4°, and the depth D=about 9.1 μm are obtained. To satisfy such a condition, the X-ray target is configured such that the embedding depth M of the W metal is set to 19.6 to 34.5 μm (D≤M≤D+r(W)) in the case of θ=27.1°, and the embedding depth M of the W metal is set to 9.1 to 24.0 μm (D≤M≤D+r(W)) in the case of θ=65.6°, and irradiation of the X-ray electron beam is inclined in the fourth approach direction, so that X-rays can be efficiently generated.

Similarly, in the case of the hexagonal grating (Example 2), when the electron beam is inclined in the first approaching direction 321, electrons having a width of about 1.6a (about 53% of the whole) among the electrons irradiating the target substrate portion of the target substrate portion do not X-ray excite the X-ray generating portions 32. Even in this case, the volume ratio of the X-ray generating portions 32 irradiated with X-rays is about 3.8 times that of the perpendicular electron beam irradiation. Therefore, it is possible to increase X-ray excitation of the X-ray generating portions 32 by about 3.8 times. In the hexagonal grating (Example 2), the target substrate is directly X-ray excited in a portion of a width 1×a (about 33% of the whole) in the direction 322 of the grating point corresponding to second approaching. On the other hand, in the third approaching direction 323, gratings having the diameter a overlap on the X-ray projection plane, and the X-ray generating portions 32 are excited by using all the electron beams. In this way, the X-ray intensity about 10 times as high as that of vertical irradiation can be obtained.

Similarly to the case of the square grating, the metal grating is closest to the first approaching direction. Thus, this direction is considered in the same way as the direction of the metal grating of the 1D grating, and the angle ψ is taken as illustrated in FIG. 14b. A distance between grating points in the third approaching is 3×(7a)^{1/2}. When a=1 μm, the distance between grating points is about 7.9 μm. In a case where the applied voltage of the electron beam for X-ray excitation is 140 kV, when calculation is performed based on Equation (7) by setting a=1 μm and b=6.9 μm, θ=23.5°, ψ=10.9°, and the depth D=about 18.5 μm are obtained in the case of n=1, and θ=53.0°, ψ=10.9°, and the depth D=about 12.1 μm are obtained in the case of n=2. Therefore, similarly to the square grating (Example 1), the X-ray target is configured such that the embedding depth M of the W metal is set to 18.5 to 33.4 μm (D≤M≤D+r(W)) in the case of θ=23.5°, and the embedding depth M of the W metal is set to 12.1 to 27.0 μm (D≤M≤D+r(W)) in the case of θ=53.0°, and irradiation of the X-ray electron beam is inclined in the third approach direction, so that X-rays can be efficiently generated.

FIG. 15 illustrates an example of an X-ray tube used for the X-ray generating apparatus of the second embodiment. As in the first embodiment, an electron source 2 and a target 3 are disposed to face each other inside an evacuated X-ray tube body 1. When a target irradiation angle θ of an electron beam is smaller than about 30 degrees, arrangement of the electron source 2 and the target 3 may be similar to that of the first embodiment. However, in a case where the irradiation angle θ is large, when the target 3 is installed at a position close to a wall surface of the X-ray tube body as illustrated in FIG. 15, it is possible to adopt a configuration in which X-rays can be extracted from a front surface direction in which the X-ray generating portions 32 are embedded and a back surface direction through a target substrate. By such an arrangement, X-rays can be extracted in two directions in a radial direction of the cylindrical X-ray tube body 1. Even in the case of a 1D grating (in the case of the first embodiment), when it is acceptable to reduce the amount of X-ray generation, this arrangement can be set so that the irradiation angle θ exceeds 35 to 40 degrees.

In the second embodiment, since the configuration and advantages other than those described above are the similar to those in the first embodiment, further detailed description of the second embodiment will be omitted. It should be appreciated that the various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

### REFERENCE SIGNS LIST

1 X-ray tube body
2 Electron source
21 Filament
22 Electron lens
23 Electron beam
3 Target
32 X-ray generating portion
35 X-ray beam
351 Bremsstrahlung (large intensity) X-ray
352 Bremsstrahlung (small intensity) X-ray
36 Target substrate
361 Groove
37 Water-cooled metal plate
38 X-ray emission hole
39 Cooling water channel
391 Inlet of cooling water channel
392 Outlet of cooling water channel
4 High-voltage power supply
41 Filament power supply
42 Bias power supply
5 Phase grating
51 Phase grating x-axis driving apparatus
52 Phase grating ϕ rotation driving apparatus
53 Phase grating ω-axis rotation driving apparatus
54 Phase grating y-axis driving apparatus
6 X-ray tube housing
7 X-ray extraction window for phase imaging
8 Phase imaging X-ray
9 Power supply apparatus
91 Connection cable
10 Water cooling apparatus
101 Cooling water pipe
110 UV mask
200 Photosensitive resist
300 SiO₂ film
400 SiC wafer

1. An X-ray generating apparatus for performing X-ray phase imaging using an X-ray excited by an electron beam irradiated from an electron source onto a target, wherein:
the target includes a target substrate formed in a flat plate shape, and X-ray generating portions arranged in a grating shape on the target substrate,
the electron source is configured such that a grating-shaped X-ray is allowed to be extracted in a direction perpendicular to the target substrate by irradiating the target with the electron beam inclined at a predetermined irradiation angle (θ) with respect to a perpendicular to the target substrate,
the target substrate includes a substance containing an element having an atomic number of 14 or less,
a plurality of grooves periodically disposed in a one-dimensional (1D) or two-dimensional (2D) direction to have a grating shape is formed on a surface of the target substrate,
the X-ray generating portions are arranged in a grating shape by being embedded in the plurality of grooves formed on the target substrate,
the X-ray generating portions contain a metal including W, Ta, Pt, or Au, or an alloy thereof, and
a depth (M) of the X-ray generating portions arranged in the grating shape is set to satisfy
D≤M≤D+r,
where r is a difference (r=R−X_{D}) between a maximum penetration depth (R) of X-ray excitation electrons irradiated as the electron beam in the X-ray generating portions and a penetration distance (X_{D}) of the X-ray excitation electrons in the X-ray generating portions, and
D is a penetration depth of the X-ray excitation electrons passing through the X-ray generating portions and the target substrate in a direction perpendicular to the target substrate.

2. The X-ray generating apparatus according to claim 1, wherein:
a ratio (a:b) of a grating width (a) of the X-ray generating portions to a grating width (b) of the target substrate is set to 1:2, and
a grating pitch (a+b) is set to be equal to or less than a penetration distance of the X-ray excitation electrons passing through both the target substrate and the X-ray generating portions.

3. The X-ray generating apparatus according to claim 1, wherein the penetration depth (D) is calculated by the following equation:
$$D = \frac{n ( a + b )}{tan θ cos ψ}$$
where n is the number of X-ray generating portions or target substrates between the plurality of grooves through which the X-ray excitation electrons pass (n≥1), and
ψ is a tilt angle of the electron beam in a plane parallel to the surface of the target substrate.

4. The X-ray generating apparatus according to claim 1, wherein the irradiation angle (θ) is set to a value between 10° and 75°.

5. The X-ray generating apparatus according to claim 1, comprising:
an X-ray tube for phase imaging, a direction of irradiating the electron beam for X-ray excitation inclined at a predetermined angle with respect to the perpendicular to the target substrate being set to such an angle (ψ) that 60% or more of the electron beam reaches an X-ray generating metal portion while the electron beam for X-ray excitation irradiates the target substrate and passes through an inside.
